(19) United States
(12) Patent Application Publication
(10) Pub. No.: US 2015/0012629 A1
(43) Pub. Date: Jan. 8, 2015

(54) PRODUCING A BENCHMARK DESCRIBING CHARACTERISTICS OF MAP AND REDUCE TASKS

(71) Applicant: HEWLETT-PACKARD DEVELOPMENT COMPANY, L.P, Houston, TX (US)

(72) Inventors: Abhishek Verma, Champayne, IL (US); Ludmila Cherkasova, Sunnyvale, CA (US)

(21) Appl. No.: 13/933,215

(22) Filed: Jul. 2, 2013

(51) Int. Cl. H04L 29/08

(52) U.S. Cl. CPC H04L 29/08135
USPC 709/223

(57) ABSTRACT

Parameter values are extracted from information regarding a workload including map tasks and reduce tasks. A benchmark specification is produced based on the extracted parameter values, the benchmark specification including parameters and respective collections of values for the parameters. Based on the benchmark specification, benchmarks are produced that describe respective characteristics of the map and reduce tasks.

### BACKGROUND

An enterprise can gather a variety of data, such as data from social websites, data from log files relating to visits of a website, data collected by sensors, financial data, and so forth. A MapReduce framework can be used to develop parallel applications for processing relatively large amounts of different data. A MapReduce framework provides a distributed arrangement of machines to process requests with respect to data.

A MapReduce job can include map tasks and reduce tasks that can be executed in parallel by multiple machines. The performance of a MapReduce job generally depends upon the configuration of the cluster of machines, and also based on the size of an input dataset.

### BRIEF DESCRIPTION OF THE DRAWINGS

Some implementations are described with respect to the following figures:

FIG. 1 is a flow diagram of a process of producing benchmarks, according to some implementations;

FIG. 2 is a schematic diagram of benchmarks and a benchmark specification, according to some implementations;

FIG. 3 is a block diagram of an example arrangement that incorporates some implementations; and

FIG. 4 is a flow diagram of a model creation process according to further implementations.

### DETAILED DESCRIPTION

Generally, a MapReduce system includes a master node and multiple slave nodes (also referred to as worker nodes). An example open-source implementation of a MapReduce system is a Hadoop system. A MapReduce job submitted to the master node is divided into multiple map tasks and multiple reduce tasks, which can be executed in parallel by the slave nodes. The map tasks are defined by a map function, while the reduce tasks are defined by a reduce function. Each of the map and reduce functions can be user-defined functions that are programmable to perform target functionalities. A MapReduce job thus has a map stage (that includes map tasks) and a reduce stage (that includes reduce tasks).

MapReduce jobs can be submitted to the master node by various requestors. In a relatively large network environment, there can be a relatively large number of requestors that are contending for resources of the network environment. Examples of network environments include cloud environments, enterprise environments, and so forth. A cloud environment provides resources that are accessible by requestors over a cloud (a collection of one or multiple networks, such as public networks). An enterprise environment provides resources that are accessible by requestors within an enterprise, such as a business concern, an educational organization, a government agency, and so forth.

Although reference is made to a MapReduce framework or system in some examples, it is noted that techniques or mechanisms according to some implementations can be applied in other distributed processing frameworks that employ map tasks and reduce tasks. More generally, “map tasks” are used to process input data to output intermediate results, based on a specified map function that defines the processing to be performed by the map tasks. “Reduce tasks” take as input partitions of the intermediate results to produce outputs, based on a specified reduce function that defines the processing to be performed by the reduce tasks. The map tasks are considered to be part of a map stage, whereas the reduce tasks are considered to be part of a reduce stage.

A MapReduce system can process unstructured data, which is data that is not in a format used in a relational database management system. Although reference is made to unstructured data in some examples, techniques or mechanisms according to some implementations can also be applied to structured data formatted for relational database management systems.

Map tasks are run in map slots of slave nodes, while reduce tasks are run in reduce slots of slave nodes. The map slots and reduce slots are considered the resources used for performing map and reduce tasks. A “slot” can refer to a time slot or alternatively, to some other share of a processing resource or storage resource that can be used for performing the respective map or reduce task.

More specifically, in some examples, the map tasks process input key-value pairs to generate a set of intermediate key-value pairs. The reduce tasks produce an output from the intermediate results. For example, the reduce tasks can merge the intermediate values associated with the same intermediate key.

The map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁,v₁)→list(k₂,v₂)

reduce(k₂,list(v₂))→list(v₃).

The reduce function merges or aggregates the values associated with the same key k₂. The multiple map tasks and multiple reduce tasks are designed to be executed in parallel across resources of a distributed computing platform that makes up a MapReduce system.

The lifecycle of a computing platform (which can include hardware and machine-readable instructions), such as a computing platform used to implement a MapReduce system, is in a range of some number of years, such as three to five years, for example. After some amount of time, an existing computing platform may have to be upgraded to a new computing platform, which can have a different configuration (in terms of a different number of computing nodes, different number of processors per computing node, different numbers of processor cores per processor, different types of hardware resources, different types of machine-readable instructions, and so forth) than the existing computing platform.

Human information technology (IT) personnel may be involved in making the decision regarding choices relating to the configuration of the new computing platform. In some cases, the decision process may be a manual process that can be based on guesses made by the IT personnel. There can be a relatively large set of different configuration choices that the IT personnel can select for the new computing platform.

In some cases, the IT personnel may select the configuration of the new computing platform based on general specifications associated with components (e.g. processors, memory devices, storage devices, etc.) of a computing platform. However, predicting performance of a new computing platform based on general specifications of platform components may not accurately capture actual performance of the new computing platform when executing production MapReduce jobs. A production job can refer to a job that is actually executed or used by an enterprise (e.g. business concern, government agency, educational organization, individual, etc.) as part of the normal operation of the enterprise.

The intricate interaction of processors, memory, and disks, combined with the complexity of the execution model of a MapReduce system (e.g. Hadoop system) and layers of machine-readable instructions (e.g. Hadoop Distributed File System (HDFS) and other software or firmware) may make it difficult to predict the performance of a computing platform based on assessing the performance of underlying components.

In accordance with some implementations, techniques or mechanisms are provided to allow for more accurate prediction of a performance of a MapReduce job on a target computing platform. The target computing platform (for implementing a MapReduce system) can be a new computing platform that is different from an existing computing platform. The new computing platform can be selected as an upgrade from the existing computing platform (which is currently being used to execute production MapReduce jobs).

A model (also referred to as a “prediction model” or “comparative model”) can be created that characterizes a relationship between a MapReduce job executing on an existing computing platform and the MapReduce job executing on the target computing platform. As discussed further below, creation of the model can be based on platform profiles generated from running benchmarks on the respective existing and new platforms. The model can be used to determine performance of a production MapReduce job on the new computing platform, given the performance of the production MapReduce job on the existing computing platform.

More generally, instead of a model that characterizes a relationship between an existing computing platform and a new computing platform, the model can characterize a relationship between a first computing platform and a second computing platform. In some cases, it is noted that the first and second computing platforms may both be new alternative computing platforms that have not yet been used to execute production MapReduce jobs. Thus, in this latter example, the comparison is not between an existing computing platform and a new computing platform, but between two new computing platforms.

The model that characterizes the relationship between the first and second computing platforms can be considered a comparative model to allow for more accurate prediction of relative performance of MapReduce jobs on the first and second computing platforms.

The predicted performance of MapReduce jobs on a computing platform can include a predicted completion time of the MapReduce job. The completion time can include a length of time, or an absolute time by which the MapReduce job can complete. In other examples, other types of performance metrics can be determined for characterizing the performance of MapReduce jobs on computing platforms.

In accordance with some examples, the model used to characterize a relationship between first and second computing platforms can model various phases of map tasks and various phases of reduce tasks. The ability to model phases of a map task and phases of a reduce task allows for more accurate determination of predicted performance on a computing platform for executing MapReduce jobs.

As noted above, creation of a model is based on executing benchmarks on the corresponding computing platforms. A benchmark includes a set of parameters and values assigned to the respective parameters. The parameters of the benchmark can characterize a size of input data, and various characteristics associated with map and reduce tasks. A benchmark can also be referred to as a synthetic microbenchmark. The benchmark can profile execution phases of a MapReduce job.

Producing an accurate benchmark (or accurate benchmarks) for purposes of predicting performance of a MapReduce job on a target computing platform can be challenging. In some examples, default or preset values can be used for various parameters of a benchmark. However, default or preset values may not accurately capture parameter values that may be present in a workload that is to be executed on the computing platform. Such a workload is also referred to as a “production workload.” A workload can include one or multiple MapReduce jobs.

In accordance with some implementations, an automated procedure can be provided for extracting customized parameter ranges that reflect properties of a production workload. Parameter values used in the customized benchmark (or benchmarks) can be tuned to reflect specific properties of the production workload. In this manner, benchmark generation can be enhanced to improve coverage of the benchmarks by using customized collections of extracted parameter values. A production workload including MapReduce jobs can be analyzed to determine what customized values should be used in a benchmark specification. Benchmarks can be created based on the benchmark specification (discussed further below).

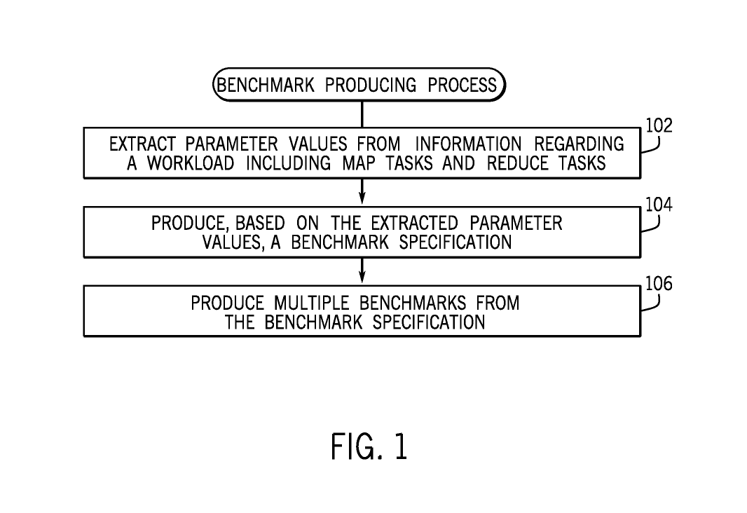

FIG. 1 is a flow diagram of a process of producing benchmarks, in accordance with some implementations. The process includes extracting (at 102) parameter values from information regarding a workload including map tasks and reduce tasks. The process produces (at 104), based on the extracted parameter values, a benchmark specification. The benchmark can specify a collection (e.g. range or other set) of values for each of multiple parameters in the benchmark specification. The parameters of the benchmark specification include those parameters that are used to parameterize benchmarks. The collections of values for the parameters in the benchmark specification can be tuned to the parameter values reflecting specific properties of a production workload.

The process then produces (at 106) multiple benchmarks from the benchmark specification. Each of the multiple benchmarks can include parameters of the benchmark specification, where the parameters of a given benchmark are assigned values taken from the respective collections of values for the respective parameters in the benchmark specification. Each benchmark describes respective characteristics of map and reduce tasks. As discussed further below, the produced benchmarks can be executed on computing platforms for creating a profile of the computing platform and to create a model that characterizes a relationship between a MapReduce job executing on the computing platforms (as noted above and as described in further detail below).

In some examples, a benchmark can include the following parameters:
Input data size (Mᵢₙₚ): The parameter Mᵢₙₚ controls the size of input data read by each map task. This parameter controls the amount of read data and affects a read phase duration (discussed further below).
Map computation (M_{comp}): The parameter M_{comp} models the computation performed by a map function. In some examples, the map function computation can be modeled as a simple loop that performs a specified calculation, such as the calculation of nth Fibonacci number (n being some specified number greater than 1) in a Fibonacci series. In other examples, the map function computation can be modeled by another sequence of code for performing a different calculation.
Map selectivity (Mₛₑₗ): The parameter Mₛₑₗ is defined as the ratio of the size of the map task output to the size of the map k input. This parameter controls the amount of data produced as the output of the map task, and therefore affects collect, spill and merge phase durations (discussed further below).
Reduce computation (R_{comp}): The parameter R_{comp} models the computation performed by reduce function. In some examples, the reduce function computation can be modeled as a simple loop that performs a specified calculation, such as the calculation of nth Fibonacci number. In other examples, the reduce function computation can be modeled by another sequence of code for performing a different calculation.
Reduce selectivity (Rₛₑₗ): The parameter Rₛₑₗ is defined as the ratio of the size of the reduce task output to the size of the reduce task input. This parameter controls the amount of output data written back to the storage subsystem 100, and therefore the parameter affects the write phase duration (explained further below).

In some implementations, a benchmark B is parametrized as:

B=(Mᵢₙₚ,M_{comp},Mₛₑₗ,R_{comp},Rₛₑₗ).

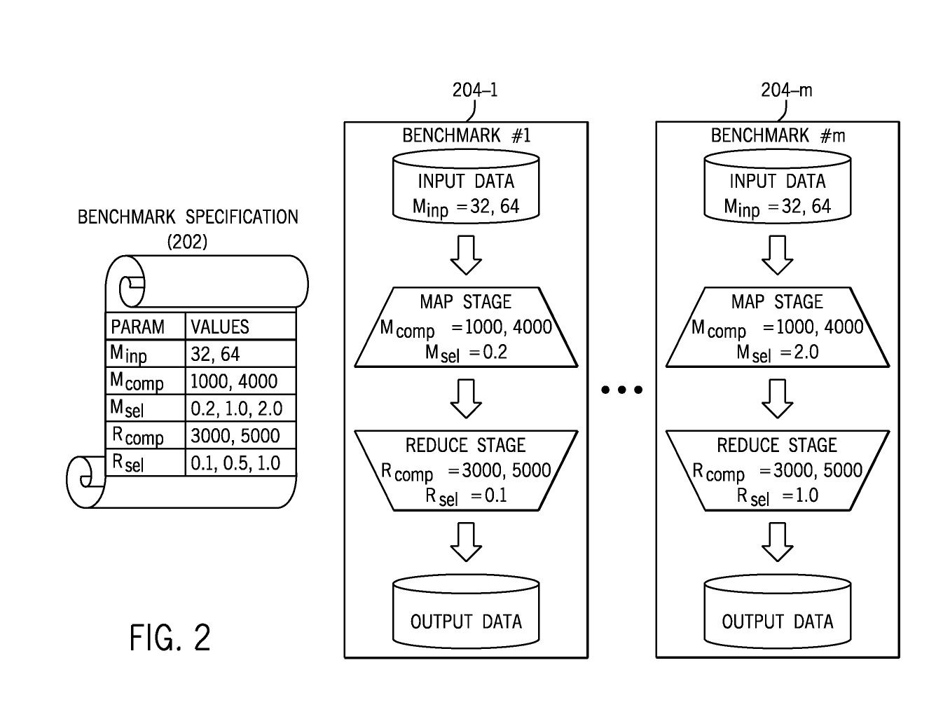

A specific benchmark can be produced by assigning values to respective ones of the parameters listed above in the benchmark B. As noted above, a collection of values can be associated with each of the benchmark parameters in a benchmark specification, such as a benchmark specification 202 depicted in FIG. 2.

In the example given in FIG. 2, the input data size parameter (Mᵢₙₚ) is associated with the following collection of values: 32, 64 (expressed in terms of gigabytes, terabytes, or some other value). Corresponding collections of values are also associated with the other benchmark parameters in the example benchmark specification 202 given in FIG. 2.

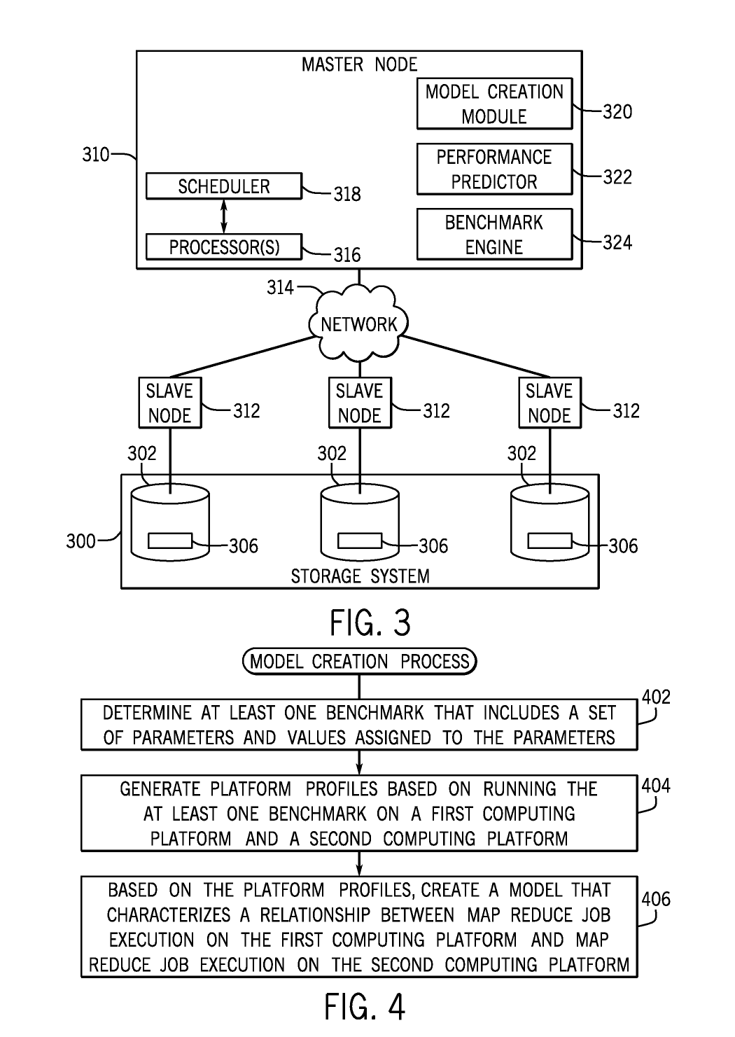

A benchmark engine (depicted as 324 in FIG. 3 and discussed further below) can use the benchmark specification 202 to produce a number of benchmarks 204-1 to 204-m, where m≧2. Each benchmark 204-i (i=1 . . . m) is produced by selecting a unique combination of the possible values for the benchmark parameters as specified in the benchmark specification 202. For example, the benchmark 204-1 uses the value 0.2 for Mₛₑₗ and the value 0.1 for Rₛₑₗ. On the other hand, the benchmark 204-m uses the value 2.0 for Mₛₑₗ and 1.0 for Rₛₑₗ. Thus, in the example of FIG. 2, each benchmark 204-i is created by selecting one value from the collection of candidate values for Mₛₑₗ specified in the benchmark specification 202, and selecting one value from the collection of candidate values for Rₛₑₗ specified in the benchmark specification 202.

The number of benchmarks 204-1 to 204-m that can be produced by the benchmark engine can depend on the number of values specified in the benchmark specification 202 for each of Mₛₑₗ and Rₛₑₗ. In the example of FIG. 2, there are three possible values for each of Mₛₑₗ and Rₛₑₗ. Thus, 9 (3×3) possible benchmarks can be created. More generally, if there are M candidate values in the benchmark specification 202 for Mₛₑₗ and R candidate values in the benchmark specification 202 for Rₛₑₗ, then the number of benchmarks that can be created is M×R. By using the benchmark specification 202, a suite of benchmarks can be easily created, where the benchmarks in the benchmark suite covers useful and diverse ranges across the benchmark parameters.

Each benchmark 204-i depicted in FIG. 2 includes an input data stage, a map stage, a reduce stage, and an output data stage. Within each benchmarks 204-i, the size of the input data (Mᵢₙₚ) for each map task can be selected in a round robin (or other) fashion from the collection of values for the Mᵢₙₚ specified in the benchmark specification 202. Similarly, within each benchmark, the value of M_{comp} the value of R_{comp} can be selected in round robin (or other) fashion for map and reduce tasks, respectively.

Selecting different values of Mᵢₙₚ, M_{comp}, and R_{comp} in a round robin or other fashion for each benchmark refers to selecting different values of Mᵢₙₚ, M_{comp}, and R_{comp} to use during execution of the benchmark in a computing platform being considered.

As noted above, a production workload can be analyzed to determine collections of values for respective parameters of the benchmark specification (e.g. benchmark specification 202 in FIG. 2). For example, the production workload (including one or multiple MapReduce jobs) can be profiled to extract the parameters of each MapReduce job in the workload. These profiles can be combined to build a CDF (Cumulative Distribution Function) of benchmark parameter values exercised by these MapReduce jobs. From the CDF plots, the appropriate values for the benchmark parameters can be derived by using a clustering technique, such as K-means clustering technique.

Choosing a smaller or larger value of K clusters in the K-means technique can influence the number of benchmark parameter values (and the number of benchmarks) used in the benchmark suite. Also, varying the number of clusters allows for greater flexibility in choosing the most popular parameter ranges. Flexibility allows a user to trade off increased computation time when a larger number of benchmarks are used, versus increased accuracy. For example, a high-level analysis can be initially performed with smaller parameter value ranges, followed by more detailed analysis.

FIG. 3 illustrates an example arrangement that includes a distributed MapReduce framework according to some examples. As depicted in FIG. 3, a storage subsystem 300 includes multiple storage modules 302, to store data. The storage modules 302 can store segments 306 of data across the multiple storage modules 302. The storage modules 302 can also store outputs of map and reduce tasks.

The storage modules 302 can be implemented with storage devices such as disk-based storage devices or integrated circuit or semiconductor storage devices. In some examples, the storage modules 302 correspond to respective different physical storage devices. In other examples, multiple ones of the storage modules 302 can be implemented on one physical storage device, where the multiple storage modules correspond to different logical partitions of the storage device.

The system of FIG. 3 further includes a master node 310 that is connected to slave nodes 312 over a network 314. The network 314 can be a private network (e.g. a local area network or wide area network) or a public network (e.g. the Internet), or some combination thereof. The master node 310 includes one or multiple processors 316. Each slave node 312 also includes one or multiple processors (not shown). Although the master node 310 is depicted as being separate from the slave nodes 312, it is noted that in alternative examples, the master node 312 can be one of the slave nodes 312.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

A computing platform (or a computing cluster) that is used to execute map tasks and reduce tasks includes the slave nodes 312 and the respective storage modules 302.

Each slave node 312 has a corresponding number of map slots and reduce slots, where map tasks are run in respective map slots, and reduce tasks are run in respective reduce slots. The number of map slots and reduce slots within each slave node 312 can be preconfigured, such as by an administrator or by some other mechanism. The available map slots and reduce slots can be allocated to the jobs.

The slave nodes 312 can periodically (or repeatedly) send messages to the master node 310 to report the number of free slots and the progress of the tasks that are currently running in the corresponding slave nodes.

In accordance with some examples, a scheduler 318 in the master node 310 is configured to perform scheduling of MapReduce jobs on the slave nodes 312. The master node 310 can also include a model creation module 320, which can be used to create a model that characterizes a relationship MapReduce job execution on a first computing platform (such as the platform depicted in FIG. 3) and a second computing platform (which can be another computing platform that is being compared to the first computing platform).

The model created by the model creation module 320 can be used by a performance predictor 322 to predict a performance of the target computing platform. Additionally, the master node 310 includes the benchmark engine 324 (discussed above) that is used to generate benchmarks from a benchmark specification (e.g. 202 in FIG. 2) that can be used by the model creation module 320 to create models.

The scheduler 318, model creation module 320, performance predictor 322, and benchmark engine 324 can be implemented as machine-readable instructions executable on one or multiple processors 316.

Although the model creation module 320, performance predictor 322, and benchmark engine 324 are depicted as being part of the master node 310 in FIG. 3, it is noted that the model creation module 320, performance predictor 322, and benchmark engine 324 can be implemented on separate computer system(s) in other examples.

FIG. 4 is a flow diagram of a process of creating a model according to some implementations. The process of FIG. 4 can be performed by the model creation module 320 and benchmark engine 324 of FIG. 3, for example. The benchmark engine 324 determines (at 402) at least one benchmark that includes a set of parameters and values assigned to the respective parameters. For example, the benchmark engine 324 can apply the process of FIG. 1 to produce the at least one benchmark. The parameters of the benchmark can characterize a size of input data, and various characteristics associated with map and reduce tasks. In some implementations, the determining task (402) of FIG. 4 can produce multiple benchmarks.

The model creation module 320 generates (at 404) platform profiles based on running the at least one benchmark on a first computing platform and on a second computing platform that is being considered as an upgrade from the existing platform. A platform profile includes values of a performance metric (e.g. completion time duration) for respective phases of map and reduce tasks. Additional discussion of these various phases is provided further below.

Based on the generated platform profiles, the model creation module 320 creates (at 406) a model that characterizes a relationship between a MapReduce job executing on the first platform and the MapReduce job executing on a second platform.

The performance of a phase of a map task or reduce task depends on the amount of data processed in each phase as well as the efficiency of the underlying computing platform involved in this phase. Since performance of a phase can depend upon the amount of data processed, there is no single value of a parameter that can characterize the performance of a phase. However, by running multiple benchmarks on each of the platforms that are considered, a model can be built that more accurately relates the phase execution times of the map and reduce tasks on the platforms.

Each map task or reduce task includes a sequence of processing phases. Each phase can be associated with a time duration, which is the time involved in completing the phase. The following are example phases of a map task:
Read phase: the read phase reads the input to a map task from a distributed file system. The read phase can read blocks of data, where a block can be of a specified size. However, a map task can also read an entire file or a compressed file. The duration of the read phase is primarily a function of read throughput from the storage subsystem 100.
Map phase: the map phase executes a map function on an input key-value pair. The duration of the map phase depends on processor performance.
Collect phase: the collect phase buffers map phase outputs into memory. The duration of the collect phase is a function of memory bandwidth.
Spill phase: the spill phase locally sorts intermediate data (produced by the map phase) for different reduce tasks, combines intermediate data, and writes intermediate data to local storage. The duration of the spill phase depends on performance of various components, including processor performance and storage access speed of the storage subsystem 100.
Merge phase: the merge phase merges different spill files into a single spill file for each reduce task. The duration of the merge phase depends on storage read and write throughput (of the storage subsystem 100).

A reduce task can include the following phases:
Shuffle phase: the shuffle phase transfers intermediate data from map tasks to reduce tasks and merge-sorts the transferred data. The shuffling and sorting can be combined because these two sub-phases are interleaved. The duration of the shuffle phase primarily depends on network shuffle performance and storage read and write throughput (of the storage subsystem 100).
Reduce phase: the reduce phase applies the reduce function on the input key and all the values corresponding to the input key. The duration of the shuffle phase depends on processor performance.
Write phase: the write phase writes the reduce output to the distributed file system in the storage subsystem 100. The duration of the write phase depends on storage write (and possibly network) throughput.

Platform profiles are generated (at 404 in FIG. 4) by running a suite of benchmarks on the computing platforms being compared. While each benchmark is running, the durations of the execution phases of all processed map and reduce tasks can be collected. A set of these measurements defines the platform profile that is used as the training data for the model to be created (task 406 in FIG. 4).

The durations of the eight execution phases listed above (read, map, collect, spill, merge, shuffle, reduce, and write) on each computing platform is collected:
Map task processing: in the platform profiles, the phase durations for respective ones of the read, map, collect, spill, and merge phases are represented as D1, D2, D3, D4, and D5, respectively.
Reduce task processing: in the platform profiles, the phase durations for respective ones of the shuffle, reduce, and write phase are represented as D6, D7, and D8, respectively.

Tables 1 and 2 show portions of a platform profile based on executing a benchmark suite on a computing platform (Table 1 shows the phase durations for map tasks and Table 2 shows the phase durations for reduce tasks):

TABLE 1

| Bench- | Map | Read | Map | Collect | Spill | Merge |
|---|---|---|---|---|---|---|
| mark | Task | msec | msec | msec | msec | msec |
| ID | ID | D1 | D2 | D3 | D4 | D5 |
| 1 | 1 | 1010 | 220 | 610 | 5310 | 10710 |
| 1 | 2 | 1120 | 310 | 750 | 5940 | 11650 |
| . . . | . . . | . . . | . . . | . . . | . . . | . . . |

TABLE 2

| Bench- | Reduce | Shuffle | Reduce | Write |
|---|---|---|---|---|
| mark | Task | msec | msec | msec |
| ID | ID | D6 | D7 | D8 |
| 1 | 1 | 10110 | 330 | 2010 |
| 1 | 2 | 9020 | 410 | 1850 |
| . . . | . . . | . . . | . . . | . . . |

In Table 1, the first column includes an identifier of a benchmark, and the second column includes an identifier of a map task. The remaining columns of Table 1 include phase durations for the phases of map tasks: D1, D2, D3, D4, and D5. The first row of Table 1 contains phase durations for the benchmark with benchmark ID 1, and the map task with map task ID 1. The second row of table 1 contains phase durations for the benchmark with benchmark ID 1, and the map task with ID 2.

Similarly, in Table 2, the first column includes the benchmark ID, and the second column includes the reduce task ID. The remaining columns of Table 2 include phase durations for the phases of reduce tasks: D6, D7, and D8.

Once the platform profiles on the computing platforms to be compared have been derived, a model can be created (task 406 in FIG. 4) using the platform profiles.

In some examples, a model M_{src→tgt} can be created that characterizes the relationship between MapReduce job executions on two different computing platforms, denoted here as src (source) and tgt (target) computing platforms. In some examples, the source computing platform can be an existing computing platform, and the target computing platform can be a new computing platform. In other examples, both the source and target computing platforms are new alternative computing platforms.

The model creation first finds the relationships between durations of different execution phases on the computing platforms. In some implementations, eight sub-models M₁, M₂, . . . , M₇, M₈ are built that define the relationships for the read, map, collect, spill, merge, shuffle, reduce, and write phases, respectively, on two computing platforms. To build these sub-models, the platform profiles gathered by executing the benchmark suite on the computing platforms being compared are used.

The following describes how to build a sub-model where 1≦i≦8. By using values from the collected platform profiles, a set of equations is formed that express the duration of each specific execution phase on the target computing platform as a linear function of the same execution phase on the source computing platform. Note that the right and left sides of equations below relate the phase duration of the same task (map or reduce) and of the same microbenchmark on two different computing platforms (by using the task and benchmark IDs):

$${D}_{i , tgt}^{1 , 1} = {A}_{i} + {B}_{i} * {D}_{i , src}^{1 , 1}$$

$${D}_{i , tgt}^{1 , 2} = {A}_{i} + {B}_{i} * {D}_{i , src}^{1 , 2}$$

$$⋯ ⋯$$

$${D}_{i , tgt}^{2 , 1} = {A}_{i} + {B}_{i} * {D}_{i , src}^{2 , 1}$$

$$⋯ ⋯$$

$$⋯ ⋯$$

where D_{i,src}^{j,k} and D_{i,tgt}^{j,k} the values of metric Dᵢ collected on the source and target platforms, respectively, for the task with ID=j during the execution of benchmark with ID=k.

To solve for (Aᵢ, Bᵢ) in the equations above, i=1 to 8, a linear regression technique can be used, such as a Least Squares Regression technique or another technique.

Let (Âᵢ, \hat{B}ᵢ), i=1 to 8, denote a solution for the set of equations above. Then Mᵢ=(Âᵢ, \hat{B}ᵢ) is the sub-model that describes the relationship between the durations of execution phase i on the source and target platforms. The entire model M_{src→tgt}=(M₁, M₂, . . . , M₇, M₈).

The training dataset (platform profiles) is gathered by the automated benchmark engine 124 that runs identical benchmarks on both the source and target platforms. The non-determinism in MapReduce processing and some unexpected anomalous or background processes, can skew the measurements, leading to outliers or incorrect data points. With ordinary least squares regression, even a few bad outliers can significantly impact the model accuracy, because it is based on minimizing the overall absolute error across multiple equations in the set.

To decrease the impact of occasional bad measurements and to improve the overall model accuracy, an iteratively re-weighted least squares technique can be used. This technique is from the Robust Regression family of techniques designed to lessen the impact of outliers.

Once the model M_{src→tgt} is created, the performance predictor 322 (FIG. 3) can use the model to predict performance of the second computing platform, based on performance of a given MapReduce job (or collection of MapReduce jobs) on the first computing platform. For example, when executing MapReduce job(s) on the first computing platform, measurements of time durations of the various map and reduce task phases can be collected. These durations can be mapped (transformed) to respective time durations of the same phases on the second computing platform, by applying the equations defining sub-models (M₁, M₂, . . . , M₇, M₈).

Machine-readable instructions of various modules described above (including 318, 320, 322, 324 of FIG. 3) are loaded for execution on a processor or processors (such 316 in FIG. 3). A processor can include a microprocessor, microcontroller, processor module or subsystem, programmable integrated circuit, programmable gate array, or another control or computing device.

Data and instructions are stored in respective storage devices, which are implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
extracting, by a system having a processor, parameter values from information regarding a workload including map tasks and reduce tasks;
producing, by the system, a benchmark specification based on the extracted parameter values, the benchmark specification including parameters and respective collections of values for the parameters; and
producing, by the system based on the benchmark specification, a plurality of benchmarks that describe respective characteristics of the map and reduce tasks.

2. The method of claim 1, wherein each of the parameters relates to a characteristic of a map task or reduce task, and wherein producing each of the plurality of benchmarks comprises selecting values from the collections of values in the benchmark specification to include in the respective benchmark.

3. The method of claim 1, wherein producing the plurality of benchmarks comprises producing the plurality of benchmarks that each includes a map selectivity parameter that represents a ratio of a size of a map task output to a size of map task input.

4. The method of claim 3, wherein producing the plurality of benchmarks comprises producing the plurality of benchmarks that each further includes a reduce selectivity parameter that represents a ratio of a size of a reduce task output to a size of a reduce task input.

5. The method of claim 4, wherein producing the plurality of benchmarks comprises producing the plurality of benchmarks that each further includes a map computation parameter that represents computation performed by a map task.

6. The method of claim 4, wherein producing the plurality of benchmarks comprises producing the plurality of benchmarks that each further includes a reduce computation parameter that represents computation performed by a reduce task.

7. The method of claim 1, further comprising:
generating platform profiles based on running the benchmarks on respective first and second computing platforms; and
creating, based on the generated platform profiles, a model that characterizes a relationship between a MapReduce job executing on the first computing platform and the MapReduce job executing on the second computing platform, wherein the MapReduce job includes the map and reduce tasks.

8. The method of claim 1, wherein each of the platform profiles includes values of a performance metric for respective phases of the map tasks and respective phases of the reduce tasks.

9. The method of claim 8, wherein generating the platform profiles comprises collecting measurements relating to phases of the map tasks and reduce tasks during running of the benchmarks on the first and second computing platforms.

10. The method of claim 1, wherein the map tasks produce intermediate results based on segments of input data, and the reduce tasks produce an output based on the intermediate results.

11. A system comprising:
at least one processor to:
extract parameter values from information regarding a workload including map tasks and reduce tasks that are to be executed on a target computing platform;
produce a benchmark specification based on the extracted parameter values, the benchmark specification including parameters and respective collections of values for the parameters, the collections of values based on the extracted parameter values;
produce, based on the benchmark specification, a plurality of benchmarks that describe respective characteristics of the map and reduce tasks;
run the benchmarks on the target computing platform;
collect measurements relating to the map tasks and reduce tasks during running of the benchmarks; and
create a model based on the collected measurements, wherein the model characterizes a relationship between execution of the map and reduce tasks on the target computing platform and execution of the map and reduce tasks on another computing platform.

12. The system of claim 11, wherein the parameters of the benchmark specification are selected from among a parameter relating to input data size, a map selectivity parameter that represents a ratio of a size of a map task output to a size of map task input, a reduce selectivity parameter that represents a ratio of a size of a reduce task output to a size of a reduce task input, a map computation parameter that represents computation performed by a map task, and a reduce computation parameter that represents computation performed by a reduce task.

13. The system of claim 11, wherein the at least one processor is to further build a distribution of parameter values exercised by the workload, and to apply clustering on the distribution of parameter values to derive the collections of values for the benchmark specification.

14. An article comprising at least one machine-readable storage medium storing instructions that upon execution cause a system to:
extract parameter values from information regarding a workload including map tasks and reduce tasks;
produce a benchmark specification based on the extracted parameter values, the benchmark specification including parameters and respective collections of values for the parameters, the parameters characterizing the map and reduce tasks; and
produce, based on the benchmark specification, a plurality of benchmarks that describe respective characteristics of the map and reduce tasks.

15. The article of claim 14, wherein producing each of the plurality of benchmarks comprises selecting values from the collections of values in the benchmark specification to include in the respective benchmark.

16. The article of claim 14, wherein the map tasks produce intermediate results based on segments of input data, and the reduce tasks produce an output based on the intermediate results.

17. The article of claim 14, wherein the parameters of the benchmark specification are selected from among a parameter relating to input data size, a map selectivity parameter that represents a ratio of a size of a map task output to a size of map task input, a reduce selectivity parameter that represents a ratio of a size of a reduce task output to a size of a reduce task input, a map computation parameter that represents computation performed by a map task, and a reduce computation parameter that represents computation performed by a reduce task.
